(19) United States
(12) Patent Application Publication
(10) Pub. No.: US 2026/0106804 A1
(43) Pub. Date: Apr. 16, 2026

(54) METHODS FOR ARTIFICIAL INTELLIEGENCE/MACHINE LEARNING (AI/ML) -BASED BLIND DETECTION OF PREEMPTION

(71) Applicant: InterDigital Patent Holdings, Inc., Wilmington, DE (US)

(72) Inventors: Asil Koc, Verdun (CA); Philip Pietraski, Jericho, NY (US); Guodong Zhang, Woodbury, NY (US); Mohamed Amine Arfaoui, Montreal (CA); John Kaewell, Jamison, PA (US)

(73) Assignee: InterDigital Patent Holdings, Inc., Wilmington, DE (US)

(21) Appl. No.: 18/914,933

(22) Filed: Oct. 14, 2024

(51) Int. Cl. H04L 41/16; H04L 5/00; H04W 72/1263

(52) U.S. Cl. CPC H04L 41/16; H04L 5/0007; H04W 72/1263

(57) ABSTRACT

A wireless transmit/receive unit (WTRU) comprises a processor configured to receive preemption configuration information from a network. The processor may be configured to receive a downlink transmission. The processor may be configured to determine, using a trained artificial intelligence (AI) or machine learning (ML) model, that one or more resources of the downlink transmission were preempted by the network without receiving a preemption indication and based on the preemption configuration information and measurements performed on the downlink transmission. The processor may be configured to send preemption detection information to the network.

### BACKGROUND

When the network (NW) preempts an ongoing physical downlink shared channel (PDSCH) transmission of a first scheduled WTRU to accommodate a second WTRU (e.g., for a latency-critical transmission), the first scheduled WTRU may receive the interrupted transmission indication (e.g., interruption radio network temporary identifier (INT-RNTI)) through downlink control information (DCI) Format 2_1 in a subsequent slot. The DCI Format 2_1 may be transmitted on a physical downlink control channel (PDCCH) within a control resource set (CORESET) in a slot. The size of DCI Format 2_1 may be up to 126 bits. Thus, the preemption indication may cause increased signaling overhead. The preemption indication may increase the processing delay for the first WTRU. Because the preemption is not learned until a later slot(s) and only a superset of radio resources is learned, there may be less time available to make a second attempt at decoding the first transmission and may be less likely to succeed. Additionally, each preemption indication with 14 bits may have low resolution in indicating the preempted time and frequency resources and may indicate more resources preempted than resources actually preempted which may cause both degraded performance and larger overhead in the form of re-transmission.

If the NW preempts critical reference signals (e.g., demodulation reference signals (DM-RS) and phase tracking reference signals (PT-RS)) of the first scheduled WTRU, the preemption may cause much more degradation than it otherwise would. In some examples, either the NW is further limited in where preemption may take place, or the performance of the first scheduled WTRU may be further degraded in the first transmission and especially in the second transmission unless there is special handling of the HARQ buffers.

The methods for AI/ML-based blind detection of preemption may reduce the signaling overhead and processing delay, while enhancing resolution of the preempted resources. The methods may enable a WTRU to train, use, and apply performance monitoring to an AI/ML model for the blind detection of preemption.

### SUMMARY

A wireless transmit/receive unit (WTRU) comprises a processor. The processor may be configured to receive preemption configuration information from a network. The processor may be configured to receive a downlink transmission. The processor may be configured to determine, using a trained artificial intelligence (AI) or machine learning (ML) model, that one or more resources of the downlink transmission were preempted by the network without receiving a preemption indication and based on the preemption configuration information and measurements performed on the downlink transmission. The processor may be configured to send preemption detection information to the network.

The preemption configuration information may include, for example, an a priori preemption probability, an indication of one or more resources that may be preempted in future downlink transmission, an indication that the a priori preemption probability is associated with one or more preemption patterns associated with future downlink transmissions, an indication that the a priori preemption probability is associated with a starting orthogonal frequency-division multiplexing (OFDM) symbol of the downlink transmission and/or an indication that the a priori preemption probability is associated with a starting subcarrier of the downlink transmission.

The processor may be configured to receive a request to report preemption operation capabilities. The processor may be configured to send a capabilities message, wherein the capabilities messages indicates that the WTRU supports blind detection of preemption.

The preemption detection information may be sent, for example, via uplink control information (UCI) or a medium access control (MAC) control element (CE). The preemption detection information may indicate, for example, one or more physical resource blocks (PRBs) or subcarriers and OFDM Symbols where the WTRU detected preemption, a number of scheduled resource blocks (RBs) that were preempted at a per RB-slot level, a number of scheduled resource blocks (RBs) that were preempted at a per RB level, or a number of scheduled resource blocks (RBs) that were preempted at a per resource element (RE) basis.

The processor may be configured to receive preemption training information. The processor may be configured to train the AI or ML model for the detection of preemption resources of one or more subsequent downlink transmission based on the preemption training information and using a supervised learning method. The processor may be configured to send training feedback information associated with the AI or ML model to the network via UCI or a MAC-CE.

The preemption training information may include, for example, randomly generated preemptions generated from a seed, an indication of one or more downlink resources that will be preempted, an indication of one or more preemption patterns used to indicate downlink resources that will be preempted, an a priori preemption probability, or an indication of one or more resources that may be preempted in future downlink transmission. The training feedback information may include, for example, an indication of a loss of the AI or ML model or an indication of a performance metric associated with the AI or ML model.

The preemption configuration information may include, for example, information to assist the WTRU to determine where preemption might occur in the downlink transmission.

The preemption information may indicate, for example, that the WTRU detected preemption of the one or more resources of the downlink transmission.

A WTRU may be configured to perform a method that includes one or more of the following steps. The method may include receiving preemption configuration information from a network. The method may include receiving a downlink transmission. The method may include determining, using a trained artificial intelligence (AI) or machine learning (ML) model, that one or more resources of the downlink transmission were preempted by the network without receiving a preemption indication and based on the preemption configuration information and measurements performed on the downlink transmission. The method may include sending preemption detection information to the network.

The preemption configuration information may include, for example, an a priori preemption probability, an indication of one or more resources that may be preempted in future downlink transmission, an indication that the a priori preemption probability is associated with one or more preemption patterns associated with future downlink transmissions, an indication that the a priori preemption probability is associated with a starting orthogonal frequency-division multiplexing (OFDM) symbol of the downlink transmission and/or an indication that the a priori preemption probability is associated with a starting subcarrier of the downlink transmission.

The method may include receiving a request to report preemption operation capabilities. The method may include sending a capabilities message, wherein the capabilities messages indicates that the WTRU supports blind detection of preemption.

The preemption detection information may be sent, for example, via uplink control information (UCI) or a medium access control (MAC) control element (CE). The preemption detection information may indicate, for example, one or more physical resource blocks (PRBs) or subcarriers and OFDM Symbols where the WTRU detected preemption, a number of scheduled resource blocks (RBs) that were preempted at a per RB-slot level, a number of scheduled resource blocks (RBs) that were preempted at a per RB level, or a number of scheduled resource blocks (RBs) that were preempted at a per resource element (RE) basis.

The method may include receiving preemption training information. The method may include training the AI or ML model for the detection of preemption resources of one or more subsequent downlink transmission based on the preemption training information and using a supervised learning method. The method may include sending training feedback information associated with the AI and/or ML model to the network via UCI and/or a MAC-CE.

The preemption training information may include, for example, randomly generated preemptions generated from a seed, an indication of one or more downlink resources that will be preempted, an indication of one or more preemption patterns used to indicate downlink resources that will be preempted, an a priori preemption probability, or an indication of one or more resources that may be preempted in future downlink transmission. The training feedback information may include, for example, an indication of a loss of the AI or ML model or an indication of a performance metric associated with the AI or ML model.

The preemption configuration information may include, for example, information to assist the WTRU to determine where preemption might occur in the downlink transmission.

The preemption information may indicate, for example, that the WTRU detected preemption of the one or more resources of the downlink transmission.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a system diagram illustrating an example Downlink Preemption by URLLC according to an embodiment.

FIG. 3 is a flowchart illustrating an example procedure for training and inference for AI/ML-based blind detection of preemption according to an embodiment.

FIG. 4 is a flowchart illustrating an example procedure for AI/ML model performance monitoring for blind detection of preemption according to an embodiment.

FIG. 5 is a system diagram illustrating an example of replacement configuration for the preempted DM-RS and PT-RS REs according to an embodiment.

### DETAILED DESCRIPTION

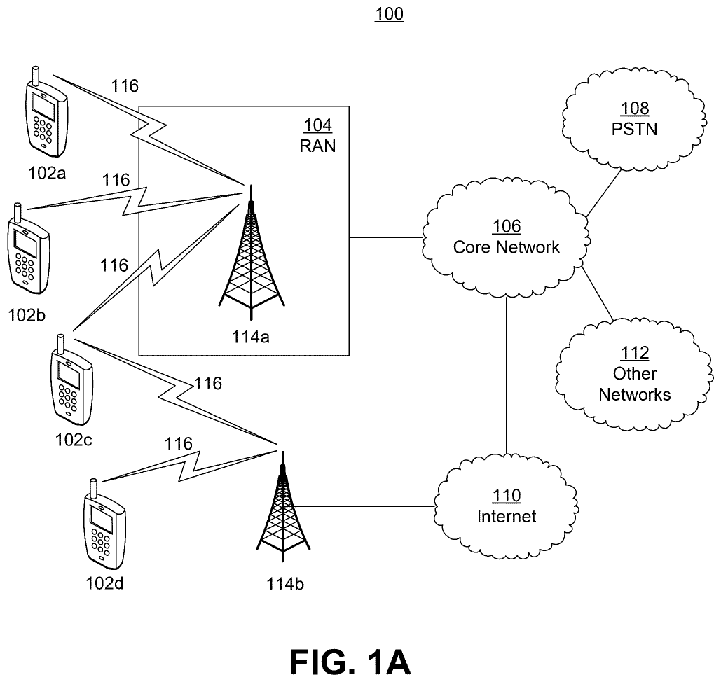

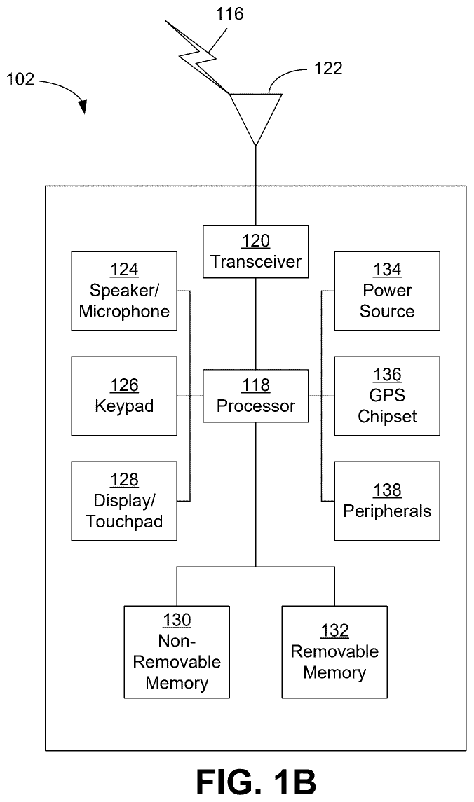

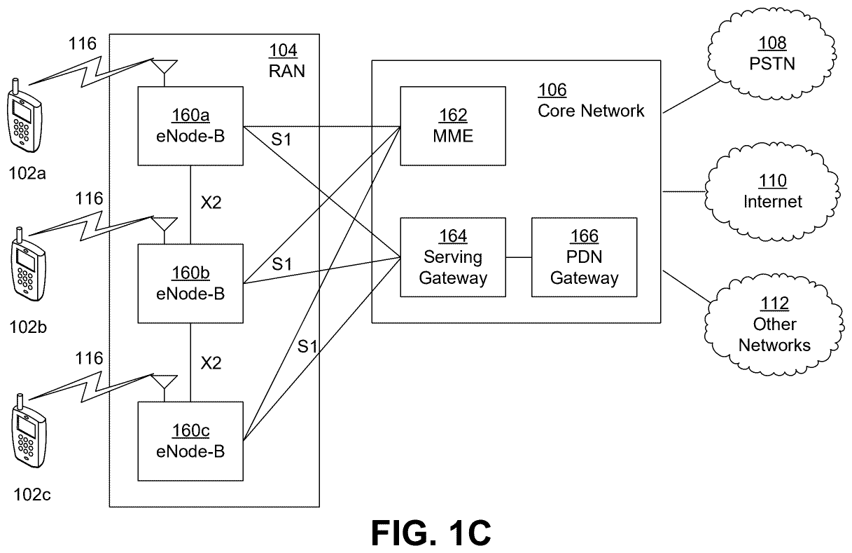

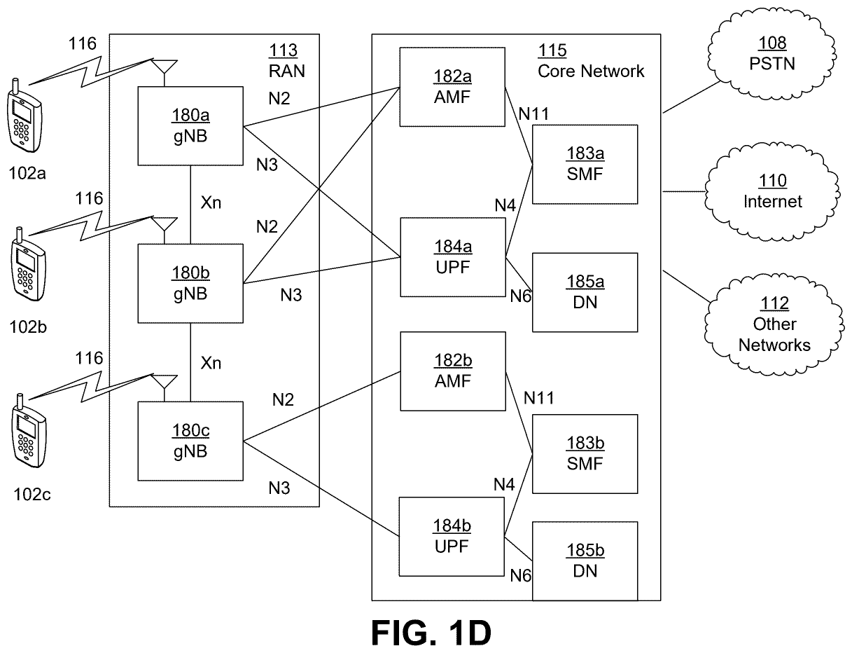

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IOT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU. Further, any description herein that is described with reference to a UE may be equally applicable to a WTRU (or vice versa). For example, a WTRU may be configured to perform any of the processes or procedures described herein as being performed by a UE (or vice versa).

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network. In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHZ, 80 MHZ, and/or 160 MHz wide channels. The 40 MHZ, and/or 80 MHZ, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHZ, 10 MHz and 20 MHz bandwidths in the TV White Space (TVWS) spectrum, and 802.11ah supports 1 MHZ, 2 MHZ, 4 MHZ, 8 MHZ, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHZ, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

When the NW preempts an ongoing PDSCH transmission of a first scheduled WTRU to accommodate a second WTRU for a latency-critical transmission, the first WTRU may receive the preemption indication through DCI Format 2_1. Thus, the preemption indication may cause increased signaling overhead and processing delay for the first WTRU. Additionally, each preemption indication with 14 bits may have low resolution in indicating the preempted time and frequency resources.

The method of AI/ML-based blind detection of preemption may reduce the signaling overhead and processing delay, while enhancing resolution of preempted time and frequency resource elements. The method may enable configuring a WTRU to train an AI/ML model for the blind detection of preemption through supervised learning. The NW may configure the WTRU (or WTRU groups) to use the trained AI/ML model for the blind detection of preemption. The WTRU may use the AI/ML model to blindly detect the preemptions without any preemption indications (e.g., DCI Format 2_1).

Artificial intelligence (AI) may be broadly defined as the behavior exhibited by machines that mimic cognitive functions to sense, reason, adapt and act. An AI component may refer to the realization of behaviors and/or conformance to requirements by learning based on data, without explicit configuration of sequence of steps of actions. Such AI component may enable learning complex behaviors which might be difficult to specify and/or implement when using legacy methods.

Machine learning (ML) may refer to the type of algorithms that solve a problem based on learning through experience (e.g., data), without being explicitly programmed (e.g., configuring a set of rules). ML may be considered as a subset of AI. Different ML paradigms may be envisioned based on the nature of data or feedback available to the learning algorithm. In an example, a supervised learning approach may involve learning a function that maps input to an output based on labeled training example, wherein each training example may be a pair consisting of an input and its corresponding output. In another example, an unsupervised learning approach may involve detecting patterns in the data with no pre-existing labels. In another example, a reinforcement learning approach may involve performing sequence of actions in an environment to maximize the cumulative reward. In some examples, it is possible to apply ML algorithms using a combination and/or interpolation of the above-mentioned approaches. For example, a semi-supervised learning approach may use a combination of a small amount of labeled data with a large amount of unlabeled data during training. In this regard semi-supervised learning falls between unsupervised learning (e.g., with no labeled training data) and supervised learning (e.g., with only labeled training data).

Deep learning may refer to a class of ML algorithms that employ artificial neural networks, specifically, Deep Neural Networks (DNNs), which were loosely inspired from biological systems. The DNNs are a special class of ML models that are inspired by the human brain wherein the input is linearly transformed and pass through non-linear activation function multiple times. DNNs consist typically of multiple layers where each layer consists of linear transformation and a given non-linear activation function. The DNNs may be trained using the training data via back-propagation algorithm. DNNs have shown state-of-the-art performance in a variety of domains, e.g., speech, vision, natural language, wireless communication, etc., and for various ML settings (supervised, un-supervised, semi-supervised, etc.).

5G NR targets supporting three generic use cases: enhanced mobile broadband (eMBB), ultra-reliable low-latency communications (URLLC), and/or massive machine-type communications (mMTC). Among them, eMBB and URLLC are two important categories targeting drastically different applications. For example, eMBB targets extremely high throughput for human-oriented services (e.g., 4K/8K video streaming), while URLLC targets low latency (e.g., 1 ms) with a guarantee of ultra-reliability (e.g., 99.999%).

The eMBB transmission time interval (TTI) may span one or multiple time slots, where a slot contains 14 OFDM symbols. The URLLC packets may be transmitted using a mini-slot to meet its latency requirements, where a mini-slot may contain 2, 4, or 7 OFDM symbols. The mini-slots may enable transmissions in a shorter time for the URLLC traffic. Additionally, considering the stringent latency requirement, the URLLC users may use higher numerology than eMBB users which also shortens the TTI.

Since the URLLC traffic may be sporadic in its nature, it can be inefficient to reserve the radio resources for the URLLC. An efficient approach utilized in NR is allowing the URLLC packets to preempt resources from on-going eMBB transmission (e.g., some radio resources already scheduled for an eMBB user may be replaced with a short transmission to the URLLC user). In this way, an URLLC packet that arrives at a gNB MAC may be immediately scheduled for transmission by preempting and/or puncturing part of an eMBB transmission.

To mitigate the effect of the described downlink preemption, the Downlink Control Information (DCI) Format 2_1 was introduced. The gNB may preempt an ongoing PDSCH transmission to one WTRU (e.g., eMBB WTRU) with a latency-critical transmission to another WTRU (i.e., URLLC WTRU). If a WTRU is preempted, the WTRU may be configured to receive an interrupted radio network temporary identifier (INT-RNTI). The INT-RNTI may be transmitted in a subsequent slot to notify the configured eMBB WTRU that a preemption in eMBB transmission has occurred. The configured eMBB WTRU may monitor PDCCH for DCI format 2_1 carrying its configured INT-RNTI. If a WTRU receives the INT-RNTI, the WTRU may assume that no useful information to that WTRU was carried by the resource elements included in the indication, even if some of those resource elements were already scheduled to this WTRU.

The DCI format 2_1 may be used for notifying Physical Resource Blocks (PRB(s)) and OFDM symbol(s), where the scheduled WTRU may assume no transmission is intended for itself. The DCI format 2_1 may carry up to 9 preemption indications, where each preemption indication has 14 bits. Thus, the size of DCI format 2_1 may be configurable by higher layers up to 126 bits. When DCI format 2_1 is configured, the period of PDCCH monitoring (e.g., monitoringSlotPeriodicityAndOffset) may be set to 1, 2, or 4 slots where DCI format 2_1 is transmitted. If a WTRU detects the DCI format 2_1 for a serving cell from the configured set of serving cells, the WTRU may assume that no transmission to the WTRU is present in PRBs and in symbols that are indicated by the DCI format 2_1, from a set of PRBs and a set of symbols of the last monitoring period.

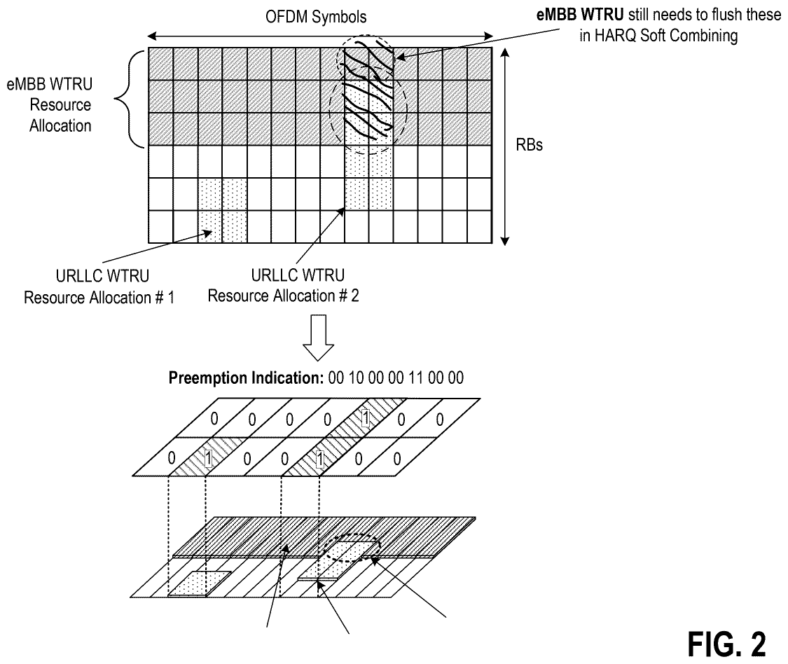

The 14-bit preemption indication may be a bit map that may be configured in two ways. For example, one configuration may be one orthogonal frequency division multiplexing (OFDM) symbol wide and spanning the whole bandwidth (BW) part/carrier. For example, one configuration may be two OFDM symbols wide and spanning one-half of the BW part/carrier. FIG. 2 presents an example of a 14-bit preemption indication with the latter configuration. The preemption itself may be contained within the preemption indication but does not necessarily use all the resources indicated by the preemption indication. The PDCCH monitoring period is a single slot so that DCI Format 2_1 is monitored every slot. In FIG. 2, the URLLC WTRU Resource Allocation #1 does not puncture any resource from eMBB WTRU, while the URLLC WTRU Resource Allocation #2 is scheduled by preempting some resources of the eMBB WTRU.

Downlink preemption may cause a degradation in the preempted packet and may degrade re-transmission since preemption replaces user signals with harmful interference in the hybrid automatic repeat request (HARQ) soft combiner buffer. When preemption occurs, the HARQ soft combining buffer includes some samples not belonging to the expected transmission (e.g., soft combining is no longer combining two versions of same signal). The DCI Format 2_1 with preemption indications informs the WTRU about the locations (e.g., OFDM symbols and PRB(s)) of preemptions so that WTRU can flush them during the HARQ soft combining. The WTRU may also attempt to decode the first preempted transmission by removing the samples indicated by the preemption indicator and forward error correction (FEC) decoding again (e.g., depending on the latency budget for positive acknowledgement (ACK)/negative acknowledgement (NACK)).

AI/ML-based blind detection of preemption may be implemented. AI/ML-based blind detection of preemption may reduce the signaling overhead and processing delay, while enhancing resolution of preempted time and frequency resource elements. The method may enable configuring a WTRU to train an AI/ML model for the blind detection of preemption through supervised learning. The WTRU may train the AI/ML model by using the received resource elements (REs) and ground-truth labels obtained via the preemption indications (e.g., DCI Format 2_1 as a superset of the time and frequency resources that may be preempted, a new preemption indication enabling the WTRU to learn the exact locations of each preempted time and frequency resource within the superset, and/or pseudo-random generation of preemption patterns). During the training and inference, the NW and/or WTRU may monitor the performance of the AI/ML model (e.g., classification accuracy in the blind detection of preemption). The WTRU and/or WTRU group may be configured to use the trained AI/ML model for the blind detection of preemption. The WTRU may use the AI/ML model to blindly detect the preemptions without the need for preemption indication (e.g., DCI Format 2_1). This may enable the WTRU to detect the preempted PRB(s) and OFDM symbol(s), where it was originally scheduled to receive a transmission but where there is no useful transmission for the WTRU. With this method, the WTRU may learn of the preemption earlier and more accurately and may use the information of the preemption to improve demodulation performance of the first transmission and may be able to retain more of the HARQ buffer for retransmission combining.

The proposed method may reduce the processing delay and signaling overhead (e.g., the method removes the requirement of preemption indication (e.g., DCI Format 2_1) transmission over PDCCH in the event of preemption). The proposed method may enhance the resolution and accuracy of preempted time and/or frequency resource elements so that WTRU does not have to assume a superset of REs are preempted. The proposed method may enable better demodulation performance in the first transmission and in re-transmissions.

The procedure for enabling AI/ML-based blind detection of preemption may be as follows. For example, the WTRU may receive (e.g. from the network) a request to report its capabilities. The WTRU may report its capabilities to the NW by means of radio resource control (RRC) signaling. In some examples, the WTRU may transmit a capability message indicating that WTRU supports AI/ML-based blind detection of preemption. In some examples, the WTRU may receive an AI/ML model for the blind detection of preemption (e.g., if the WTRU does not have the AI/ML model for the blind detection of preemption).

In some examples, the WTRU may be configured with a preemption pattern (e.g., through RRC signaling). The preemption pattern may include an a priori overall preemption probability to determine and/or set a threshold to blindly detect the preemption. The preemption pattern may include an a priori preemption probability to determine and/or set a threshold to blindly detect the preemption. The preemption pattern may include a finite number of preemption possibilities (e.g., the combinations of subcarriers (or RBs) and OFDM symbols, possible patterns of preemption on the time-frequency resource grid, etc.). The finite number of preemption possibilities may be used to limit the possible classification that blind detection ML needs to make and thereby improve performance. Each possible preemption shape may be indicated by a first and/or second RB-symbol index into the time-frequency resource grid. A priori probabilities may be assigned to each of the preemption possibilities. A priori probabilities may be assigned to starting OFDM symbol for a preemption.

In some examples, the WTRU may be configured to use an AI/ML model for the blind detection of preemption. In some examples the WTRU may be scheduled to receive and may receive a downlink transmission over a set of time and frequency resources.

In some examples, the WTRU may use a trained AI/ML model to blindly detect the preemptions without the receiving preemption indication from the NW (e.g., DCI Format 2_1), based on measurements performed on the received DL transmission. For instance, the WTRU may detect the preempted PRBs (or subcarriers) and OFDM Symbols, where there is no transmission for itself. The detection may be performed based on one or more of measurements of the received downlink transmission, decoding performance, and/or reception of indication of possible preemption. The WTRU may perform the data detection with the blindly detected preemption detection information. The WTRU may be configured to exclude the preempted resources from the received data processing (e.g., setting log-likelihood ratio (LLR) to zero for the preempted resources, excluding them in the HARQ process). The WTRU may be configured to use both the received (e.g., legacy and/or modified) preemption indications (e.g., DCI Format 2_1) and/or the AI/ML model for the blind detection of preemption (e.g., to enhance the resolution of preempted REs in time and frequency). For example, the legacy preemption indication may include 14 bits. In other examples, the modified preemption indication may carry less or more bits. For instance, the modified preemption indication may carry a single bit to indicate whether there is any preemption in the ongoing transmission (e.g., bit 0 represents no preemption, bit 1 represents preemption). The single bit preemption indication may not provide the location of preemption. Thus, AI/ML model may be utilized to enhance the resolution of preempted time/frequency resource elements. For example, if the blindly detected preemption is contained in the preemption indication, the WTRU may use the blindly detected preemption. If there is no blindly detected preemption and legacy (e.g., 14 bit) preemption indication is used and/or other multi-bit preemption indication is used, the WTRU may use blindly detected preemption for preemption processing. If there is no blindly detected preemption and one-bit preemption indication is used, the WTRU may indicate to NW (e.g., this failure may indicate a need for re-training).

In some examples, the WTRU may be configured to monitor the AI/ML model performance for the blind detection of preemption (e.g., enabling WTRU-side performance monitoring). For instance, the WTRU may be configured to monitor the preemption indication (e.g., DCI Format 2_1, a new preemption indication with the exact locations of each preempted time and frequency resource) to apply the performance monitoring and to report the trained and/or deployed AI/ML model performance (e.g., classification accuracy in blind detection of preemption).

In some examples, the WTRU reports the performance monitoring feedback of the blind preemption detection through uplink control information (UCI) or MAC control element (CE) (e.g., enabling NW-side performance monitoring). The performance monitoring feedback of the blind preemption detection may have various sizes. For example, performance monitoring feedback may be a single-bit preemption feedback to indicate whether a preemption is detected or not during the on-going transmission. The performance monitoring feedback may be 14-bit or less preemption feedback similar to the legacy preemption indication (INT-RNTI). This feedback may indicate the PRBs (or subcarriers) and OFDM Symbols, where the preemption is detected. The performance monitoring feedback may be N_{RB} bit preemption feedback. N_{RB} bit preemption feedback may target an improved resolution about the preemption feedback, where N_{RB} represents the number of scheduled RBs. This feedback may provide the detected preemption detection information whether the preemption is detected per RB-slot level. The performance monitoring feedback may be 14×N_{RB} bit preemption feedback. 14×N_{RB} bit preemption feedback may target an improved resolution about the preemption feedback. This feedback may provide the information whether the preemption is detected per RB level. The performance monitoring feedback may be 14×12×N_{RB} bit preemption feedback. 14×12×N_{RB} bit preemption feedback may target an improved resolution about the preemption feedback. This feedback may provide the information whether the preemption is detected in each resource element. The performance monitoring feedback of the blind preemption detection may be periodic, aperiodic, or semi-persistent.

Training of AI/ML model for the blind detection of preemption may be implemented. In some examples, the WTRU may be configured to train an AI/ML model for the blind detection of preemption (e.g., through supervised learning). During the training, the WTRU may be configured to receive the randomly generated preemptions (e.g., URLLC allocations) generated from a seed or other patterns instead of receiving the preemption indication. The WTRU may be configured to receive the preemption indications including DCI Format 2_1 as a superset of the preempted time and frequency resources. The WTRU may be configured to receive the preemption indications including a new preemption indication enabling the WTRU to learn the exact locations of each preempted time and frequency resource.

The WTRU may train the AI/ML model through input and output data. The input data may include a priori overall preemption probability. The input data may include a priori preemption probability. The input data may include a set of preemption possibilities (e.g., RBs and symbol combinations). The input data may include received data REs. The input data may include received DM-RS REs. The input data may include received PT-RS REs. The input data may include received channel state information reference signals (CSI-RS) REs. The input data may include reference signal received power (RSRP). The WTRU may train the AI/ML model through output data. The output data may be generated through the ground-truth labels indicating whether the resources are preempted or not by using the received preemption indication from the NW. The preemption indication to generate the ground-truth labels may include DCI Format 2_1 as a superset of the preempted time & frequency resources. The preemption indication to generate the ground-truth labels may include a new preemption indication enabling the WTRU to learn the exact locations of each preempted time and frequency resource.

The WTRU may be configured with the learning algorithm, learning rates, regularization parameters, etc. The WTRU may be configured with the total number of training sessions. The WTRU may be configured with the loss function (e.g., binary cross entropy, mean square error).

The WTRU may be configured with the loss threshold to monitor the training progress. The WTRU may be configured with the training performance metric (e.g., classification accuracy). The WTRU may be configured to exclude the preempted resources from the received data processing (e.g., setting log-likelihood ratio (LLR) to zero for the preempted resources).

The WTRU may send the training feedback of the blind preemption detection to the NW (e.g., through UCI or MAC-CE). The training feedback of the blind preemption detection may include the AI/ML model loss and/or the AI/ML model performance metric (e.g., classification accuracy). The NW may detect whether the training is sufficient through the received training feedback of the blind preemption detection.

The WTRU may send a message (e.g., “training complete”) to the NW (e.g., through UCI or MAC-CE), when the WTRU detects the training is sufficient. The NW may use this message for deciding to stop or continue the training. For example, the NW may stop the training by stopping the transmission of the randomly generated preemptions (e.g., URLLC allocations).

Replacement Configuration for Preempted DM-RS & PT-RS may be implemented. The NW may preempt the resources of a first scheduled WTRU to accommodate a second WTRU for a latency-critical transmission, where the preempted resources may carry the critical reference signals (e.g., DM-RS and PT-RS) for the first scheduled WTRU. The method discussed herein may enable the first scheduled WTRU to enhance its data demodulation, when the NW preempts its scheduled resources carrying the critical reference signals. The method discussed herein may be applicable for various reference signals. The method herein discusses the preempted DM-RS and/or PT-RS as an example. When OFDM symbols carrying DM-RS and PT-RS are preempted, some and/or all of the reference signals may be replaced by putting them in scheduled REs that were not preempted. The WTRU may learn the new pattern of reference signals from a preconfigured rule that tells the WTRU how to map the preempted resources and/or DCI Format 2_1 pattern and the existing reference signal pattern into a new reference signal pattern. Additionally and/or alternatively, the WTRU may be signaled with the new reference signal pattern in an extended version of the DCI Format 2_1. The WTRU may be configured to use one of a set of standardized formulas (e.g., Method 1) as a default. The WTRU may instead and/or in addition to receive the preemption configuration through RRC (e.g., Method 2) which would override Method 1. The WTRU may instead and/or in addition to receive an extended version of DCI Format 2_1 (e.g., Method 3) to determine the replacement DM-RS & PT-RS configuration.

The procedures for replacement configuration for preempted DM-RS & PT-RS may be as follows. For example, the WTRU may receive (e.g., from the NW) a request to report the preemption capabilities. The WTRU may transmit a capabilities message indicating that WTRU may support changing the location of preempted DM-RS REs and/or PT-RS REs, when OFDM symbols carrying DM-RS and/or PT-RS REs are preempted. In some examples, the WTRU may monitor the preempted resources through either the received interrupted transmission indication (INT-RNTI) and/or AI/ML-based blind detection of the preemption (as discussed above). In some examples, the WTRU may determine that one or more DM-RS and/or PT-RS transmissions are preempted in a transmission.

In some examples, the WTRU and/or WTRU group may determine a replacement DM-RS and/or PT-RS configuration (e.g., to replace the determined one or more DM-RS and/or PT-RS transmissions) using one and/or a combination of the following methods. For example, the WTRU and/or WTRU group may determine a replacement DM-RS and/or PT-RS configuration using Method 1 (e.g., Rule-based method). Method 1 may be a fixed relationship between the originally scheduled DM-RS and/or PT-RS configuration and the replacement DM-RS and/or PT-RS configuration. For instance, the WTRU may be configured to use one standardized relationship as a default. The WTRU may determine the replacement DM-RS and/or PT-RS configuration-RS REs by applying the standardized relationship. The standardized relationship may be a rule-based solution.

The WTRU and/or WTRU group may determine a replacement DM-RS and/or PT-RS configuration using Method 2 (e.g., RRC-based solution). In using Method 2, the WTRU may receive the replacement DM-RS and/or PT-RS configuration via signaling (e.g., RRC signaling). The WTRU and/or WTRU group may determine a replacement DM-RS and/or PT-RS configuration using Method 3 (e.g., DCI-based solution). In using Method 3, the WTRU may receive the replacement DM-RS and/or PT-RS configuration via DCI (e.g., by an extended version of DCI Format 2_1).

In some examples, the WTRU may apply the determined reference signal replacement configuration to receive the corresponding reference signal REs.

AI/ML-based blind detection of preemption may be implemented. AI/ML-based blind detection of preemption may reduce the signaling overhead and processing delay, while enhancing resolution of preempted time and frequency resource elements. The proposed method may enable configuring a WTRU to train an AI/ML model for the blind detection of preemption through supervised learning. The WTRU may train the AI/ML model by the received REs and ground-truth labels obtained through the preemption indications (e.g., DCI Format 2_1 as a superset of the preempted time and frequency resources and/or a new preemption indication enabling the WTRU to learn the exact locations of each preempted time and frequency resource). During the training and inference, the NW and/or WTRU may monitor the performance of AI/ML model (e.g., classification accuracy in the blind detection of preemption). The NW may configure the WTRU and/or WTRU groups to use the trained AI/ML model for the blind detection of preemption. The WTRU may use the AI/ML model to blindly detect the preemptions without DCI Format 2_1. This may enable the WTRU to detect the preempted PRB(s) and OFDM symbol(s), where no useful transmission for itself. The WTRU may perform the data detection with the blindly detected preemption detection information.

The proposed method may reduce the processing delay and signaling overhead (i.e., it removes the requirement of DCI Format 2_1 transmission over PDCCH in the event of preemption). The proposed method may enhance the resolution of preempted time/frequency resource elements.

The WTRU may perform the blind detection of preemption through an AI/ML model. The stages of the AI/ML process are detailed as follows. For example, the AI/ML model application may be blind detection of preemption. The AI/ML model input may include a priori overall preemption probability. The input data may include a priori preemption probability. The input data may include a set of preemption possibilities (RBs and symbol combinations). For instance, the possible preemption(s) may be a rectangular region in time/frequency grid. The possible preemption(s) may have an integer multiple of RBs. The input data may include received data REs. The input data may include received DM-RS REs. The input data may include received PT-RS REs. The input data may include received channel state information reference signals (CSI-RS) REs. The input data may include reference signal received power (RSRP). The input data may include decoding performance. The input data may include reception of indication of possible preemption (e.g., the preemption is possible, likely, not possible, not likely, etc.).

In some examples, the stages of the AI/ML process may include pre-processing. The preprocessing may include extraction of the received data REs from the received signals using the configured data locations (e.g., allocations). The preprocessing may include extraction of the received DM-RS REs from the received signals using the configured DM-RS locations (e.g., allocations). For instance, division of the received DM-RS REs by known DM-RS pilots. For instance, multiplication of the received DM-RS REs by conjugate of the known DM-RS pilots.

The preprocessing may include extraction of the received PT-RS REs from the received signals using the configured PT-RS locations (e.g., allocations). For instance, division of the received PT-RS REs by known PT-RS pilots. For instance, multiplication of the received PT-RS REs by conjugate of the known PT-RS pilots.

The preprocessing may include extraction of the received CSI-RS REs from the received signals using the configured CSI-RS locations (e.g., allocations). For instance, division of the received CSI-RS REs by known CSI-RS pilots. For instance, multiplication of the received CSI-RS REs by conjugate of the known CSI-RS pilots. The preprocessing may include reshaping the input data shape. The preprocessing may include concatenation of the real and imaginary parts to obtain a real-valued AI/ML model input.

In some examples, the stages of the AI/ML process may include an AI/ML Model. For instance, the blind detection of preemption can be considered as a multi-label classification (e.g., multi-class classification) problem. Thus, the AI/ML model predicts the preemption detection information. In some examples, the stages of the AI/ML process may include post-processing. Post-processing may include rounding the AI/ML model outputs to either 0 (e.g., no preemption) or 1 (e.g., preemption). Post-processing may include threshold tuning. For example, the AI/ML model may output the probabilities of preemption between 0 and 1. Instead of classifying the probabilities larger than 0.5 as preemption, a threshold may be tuned to improve the classification accuracy. The threshold may be a function of a priori preemption probability. Post-processing may include reshaping the AI/ML model output.

The stages of the AI/ML process may include output data. AI/ML model output may include the predicted/detected preemption detection information. The output size of AI/ML model may vary and depend on the resolution of preemption detection information. The examples for different output sizes are as follows. For example, the AI/ML model may have 14 outputs indicating the locations of preempted PRBs and/or OFDM symbols as in the preemption indication with 14 bits carried in DCI Format 2_1. For example, The AI/ML model may have 14×12×N_{RB} outputs indicating the locations of each preempted RE to enhance the resolution of preempted time/frequency resource elements, where N_{RB} represents the number of scheduled RBs.

The stages of the AI/ML process may include training. The training may be performed online through supervised learning. For instance, the WTRU may generate the input dataset by storing the received REs. The WTRU may generate the ground-truth labels indicating whether the resources are preempted or not through DCI Format 2_1.

The stages of the AI/ML process may include inference. For example, the WTRU may be configured to use the trained AI/ML model for the blind detection of preemption. The WTRU may use the trained AI/ML model to blindly detect the preemptions without receiving DCI Format 2_1. The WTRU may detect the preempted PRBs (or subcarriers) and OFDM Symbols, where there is no transmission for itself. The WTRU may perform the data detection with the blindly detected preemption detection information.

The stages of the AI/ML process may include performance monitoring. For example, during the training and/or inference, the WTRU may be configured to monitor the AI/ML model performance for the blind detection of preemption. During the training and/or inference, the WTRU may be configured to report the performance monitoring feedback of the blind preemption detection through UCI and/or MAC-CE.

WTRU capability exchange may be implemented. The NW may initiate the WTRU capability exchange process by sending the WTRUCapabilityEnquiry RRC message to the WTRU. This message may be used to request specific information regarding the WTRU's capabilities. The NW may include parameters in this message to specify which capabilities related to the preemption (e.g., Downlink Preemption). The NW may specify parameters related to WTRU's capability in online learning of an AI/ML-based blind detection of preemption in WTRUCapabilityEnquiry message.

Upon receiving the WTRU capability enquiry RRC message, the WTRU may respond with the WTRUCapabilityInformation RRC message accordingly. The message may include detailed information about the WTRU's capabilities. During the WTRU capability exchange process between the WTRU and the NW, the following key parameters related to the AI/ML functions may be included. For example, an indicator of whether online training of AI/ML-based blind detection of preemption is supported or not may be a key parameter included during the WTRU capability exchange process between the WTRU and the NW. An indicator of whether using the trained AI/ML model to blindly detect the preemptions is supported or not may be a key parameter included during the WTRU capability exchange process between the WTRU and the NW. An indicator of whether using the trained AI/ML model to blindly detect the preemptions without the receiving preemption indication (e.g., DCI Format 2_1) from the NW is supported or not may be a key parameter included during the WTRU capability exchange process between the WTRU and the NW. An indicator of whether monitoring the AI/ML model performance for the blind detection of preemption is supported or not may be a key parameter included during the WTRU capability exchange process between the WTRU and the NW. An indicator of whether reporting the training feedback of the blind preemption detection is supported or not may be a key parameter included during the WTRU capability exchange process between the WTRU and the NW. An indicator of whether reporting the performance monitoring feedback of the blind preemption detection is supported or not may be a key parameter included during the WTRU capability exchange process between the WTRU and the NW.

WTRU configuration to train the AI/ML model for the blind detection of preemption may be implemented. Through WTRU capability exchange process as described above, the NW knows the WTRU's capability to support the training, usage and performance monitoring of the AI/ML model for the blind detection of preemption. When a WTRU is configured to train its AI/ML model for the blind detection of preemption, the key parameters may be configured by the NW, which may include the following. For example, a key parameter that may be configured by the network may be the preemption pattern. The preemption pattern may include a priori overall preemption probability to determine and/or set a threshold to blindly detect the preemption. The preemption pattern may include a priori preemption probability to determine and/or set a threshold to blindly detect the preemption. The preemption pattern may include a finite number of preemption possibilities (e.g., RBs and symbol combinations) to be used for training the blind detection. A priori probabilities may be assigned to each finite number of preemption possibility. For example, a key parameter that may be configured by the network may be the training related information. The training related information may include the learning algorithm, learning rates, regularization parameters, etc. The training related information may include the total number of training sessions. The training related information may include the loss function (e.g., binary cross entropy). The training related information may include the loss threshold to monitor the training progress. The training related information may include the training performance metric (e.g., classification accuracy).

WTRU and/or NW signaling may be implemented. The following signals are defined to enable the WTRU and/or NW to detect the need for initiating training and/or performance monitoring of AI/ML-based blind detection of preemption, and to enable the WTRU to use the trained AI/ML model for the blind detection of preemption. For example, signals to enable the WTRU and/or NW may include a preemption pattern transmitted from the NW to the WTRU (e.g., through DCI and/or MAC-CE). Signals to enable the WTRU and/or NW may include training activation for the blind detection of preemption transmitted from the NW to the WTRU (e.g., through DCI and/or MAC-CE). Signals to enable the WTRU and/or NW may include a performance threshold metric for the AI/ML model (e.g., classification accuracy) transmitted from the NW to the WTRU. Signals to enable the WTRU and/or NW may include an indication that training of the model is complete transmitted from the WTRU to the NW. Signals to enable the WTRU and/or NW may include an indication to use the trained AI/ML model to blindly detect the preemptions together with the preemption indication (e.g., DCI Format 2_1) transmitted from the NW to the WTRU. Signals to enable the WTRU and/or NW may include an indication to use the trained AI/ML model to blindly detect the preemptions without receiving any preemption indication transmitted from the NW to the WTRU. Signals to enable the WTRU and/or NW may include an indication to monitor the AI/ML model performance for the blind detection of preemption transmitted from the NW to the WTRU. Signals to enable the WTRU and/or NW may include an indication to report the training feedback of the blind preemption detection transmitted from the NW to the WTRU. Signals to enable the WTRU and/or NW may include an indication to report the performance monitoring feedback of the blind preemption detection transmitted from the NW to the WTRU. Signals to enable the WTRU and/or NW may include the training feedback of the blind preemption detection transmitted from the WTRU to the NW. Signals to enable the WTRU and/or NW may include the performance monitoring feedback of the blind preemption detection transmitted from the WTRU to the NW.

The methods discussed above and herein may be implemented using rule-based decision making. For example, using “if-then” statements, predefined rules and/or other rule-based methods/systems, either alone and/or in conjunction with AI/ML, to perform blind detection of preemption may be implemented.

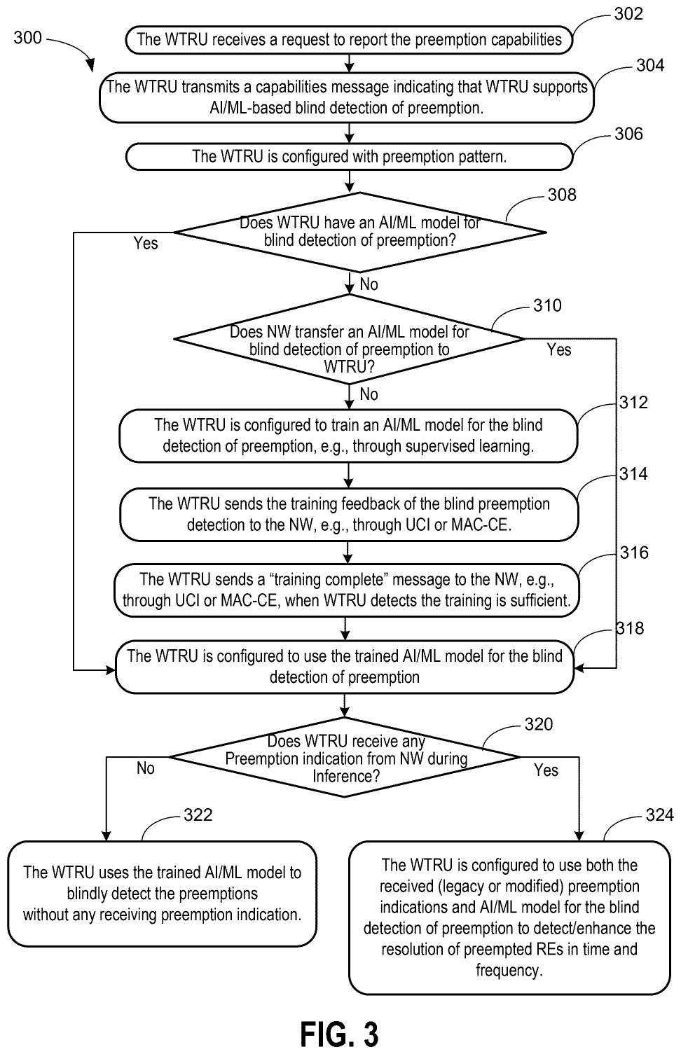

FIG. 3 is an example of a procedure 300 for training and inference for AI/ML-based blind detection of preemption. The procedure 300 may be performed by a WTRU. At 302, the WTRU may receive a request to report the preemption capabilities. At 304, the WTRU may transmit a capabilities message indicating that the WTRU supports AL/ML based blind detection of preemption. At 306, the WTRU may be configured with a preemption pattern. The WTRU may be configured with a preemption pattern through RRC signaling and may include a priori preemption probability and/or a finite number of preemption possibilities. At 308, the WTRU is queried if the WTRU has an AI/ML model for blind detection of preemption. If yes, at 318 it is determined that the WTRU is configured to use the trained AI/ML model for the blind detection of preemption. If at 308 the answer is no, at 310 the WTRU is queried if the NW can transfer an AI/ML model for blind detection of preemption. If yes, at 318 it is determined that the WTRU is configured to use the trained AI/ML model for the blind detection of preemption. If no, at 312 the WTRU is configured to train an AI/ML model for the blind detection of preemption (e.g., supervised learning). At 314, the WTRU sends the training feedback of the blind preemption detection to the NW (e.g., through UCI and/or MAC-CE). At 316, the WTRU sends a “training complete” message to the network (e.g., through UCI and/or MAC-CE) when the WTRU detects that the training is sufficient. At 318, it is determined that the WTRU is configured to use the trained AI/ML model for the blind detection of preemption. At 320, the WTRU is queried if the WTRU receives any preemption indication from the NW during inference. If no, at 322 the WTRU uses the trained AL/ML model to blindly detect the preemptions without receiving preemption indications. If yes, at 324 the WTRU is configured to use both the received (e.g., legacy and/or modified) preemption indication and the AI/ML model for blind detection of preemption to detect and/or enhance the resolution of preemption REs in time and frequency.

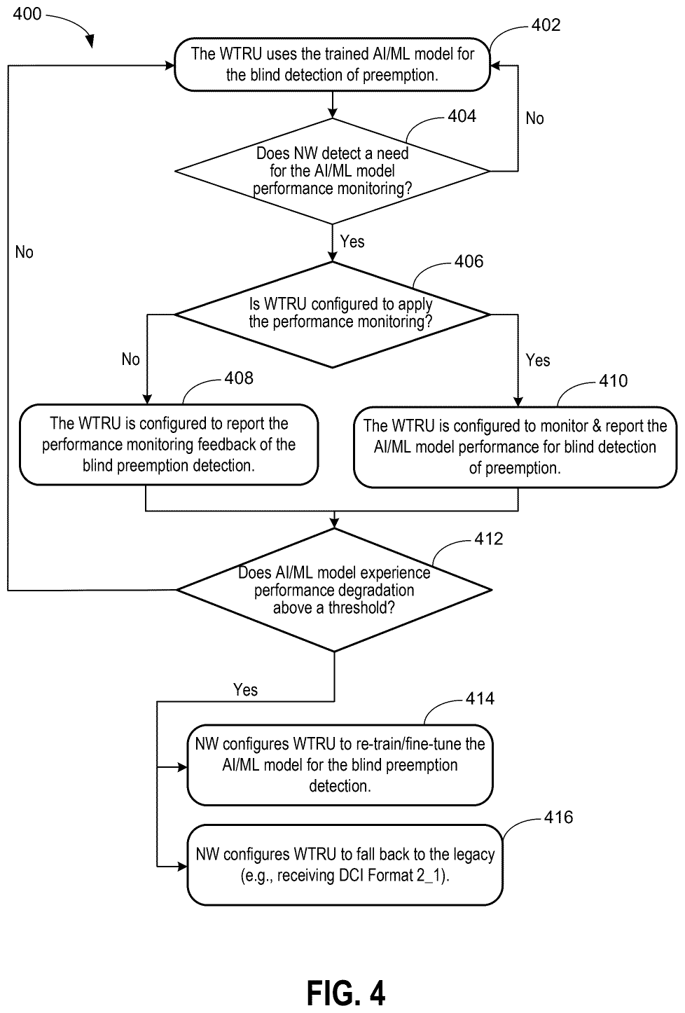

FIG. 4 is an example of a procedure 400 for AI/ML model performance monitoring for blind detection of preemption. The procedure 400 may be performed by a WTRU. At 402, the WTRU uses the trained AI/ML model for the blind detection of preemption. At 404, the NW is queried if the NW detects a need for the AI/ML model performance monitoring. If no, the procedure proceeds back to step 402. If yes, at 406 the WTRU is queried if the WTRU is configured to apply the performance monitoring. If no, the WTRU is configured to report the performance monitoring feedback of the blind preemption detection. If yes, at 410 the WTRU is configured to monitor and report the AI/ML model performance for blind detection of preemption. At 412, the WTRU is queried if the AI/ML model experiences performance degradation above a threshold. If no, the procedure proceeds back to step 402. If yes, at 414 the NW may configure the WTRU to retrain and/or fine-tune the AI/ML model for the blind preemption detection. Additionally, if yes, at 416 the NW may configure the WTRU to fall back to the legacy (e.g., receiving DCI format 2_1).

Replacement configuration for preempted DM-RS & PT-RS may be implemented. The NW may preempt the resources of a first scheduled WTRU to accommodate a second WTRU for a latency-critical transmission, where the preempted resources may carry the critical reference signals (e.g., DM-RS and/or PT-RS) for the first scheduled WTRU. The method discussed herein may enable the first scheduled WTRU to enhance its data demodulation, when the NW preempts its scheduled resources carrying the critical reference signals. The method discussed herein may be applicable for various reference signals. The method herein discusses the preempted DM-RS and/or PT-RS as an example. When OFDM symbols carrying DM-RS and/or PT-RS are preempted, some or all of the reference signals may be replaced by putting them in scheduled REs that were not preempted. The WTRU may learn the new pattern of reference signals from a preconfigured rule that tells the WTRU how to map the preempted resources and/or DCI Format 2_1 pattern and the existing reference signal pattern into a new reference signal pattern. Additionally and/or alternatively, the WTRU may be signaled with the new reference signal pattern in an extended version of the DCI Format 2_1. The WTRU may be configured to use one of a set of standardized formulas (e.g., Method 1) as a default. The WTRU may instead and/or in addition to receive the preemption configuration through RRC (e.g. Method 2) which would override Method 1. The WTRU may instead and/or in addition to receive an extended version of DCI Format 2_1 (e.g., Method 3) to determine the replacement DM-RS & PT-RS configuration.

Methods for replacement configuration (e.g., three methods for a WTRU to determine the replacement DM-RS and PT-RS configuration) may be implemented. For example, Method 1 (e.g. rule-based solution) may be a fixed relationship between the originally scheduled DM-RS and/or PT-RS configuration and the replacement DM-RS and/or PT-RS configuration. For instance, the WTRU may be configured to use one standardized relationship as a default. The WTRU may determine the replacement DM-RS and/or PT-RS configuration by applying the standardized relationship. The standardized relationship in Method 1 may be a rule-based solution. For example, when the WTRU determines that there is a preemption on OFDM symbol(s) carrying DM-RS REs, the WTRU may receive the DM-RS REs in scheduled REs that are determined to not be preempted. The replacement configuration may be the nth OFDM symbol (e.g., the first or second or third OFDM symbol) after the preempted OFDM symbol(s). Method 2 may be a RRC-based solution. For example, the WTRU receives the replacement DM-RS and/or PT-RS configuration via signaling (e.g., RRC signaling). For instance, a Method 2 message may include a rule-based solution. Unlike the fixed standardized relationship in Method 1, Method 2 message is configured through RRC signaling. For instance, a Method 2 message may be a semi-persistent signaling through RRC. A Method 2 message may override Method 1. A new field of RS-ReplacementConfiguration may be added into the RRC IE DownlinkPreemption (e.g., as shown below), which is used to configure the WTRU to monitor PDCCH for the INT-RNTI (e.g., interruption).

DownlinkPreemption Information Element

[symbol]

[symbol]

| | |
|---|---|
| DownlinkPreemption ::= | SEQUENCE { |
| int-RNTI | RNTI-Value, |
| timeFrequencySet | [symbol] {set0, set1}, |
| dci-PayloadSize | INTEGER (0..maxINT-DCI-PayloadSize), |
| int-ConfigurationPerServingCell | SEQUENCE (SIZE (1..maxNrofServingCells)) OF INT- |

ConfigurationPerServingCell,

| | |
|---|---|
| [symbol] | [symbol] {formula0, formula1, ..., formulaK}, |

...
}

| | |
|---|---|
| INT-ConfigurationPerServingCell ::= | SEQUENCE { |
| servingCellId | ServCellIndex, |
| positionInDCI | INTEGER (0..maxINT-DCI-PayloadSize−1) |

}

[symbol]

[symbol]

[symbol]

indicates data missing or illegible when filed

Method 3 may be a DCI-based solution. For example, the WTRU may receive the replacement DM-RS and/or PT-RS configuration via DCI (e.g., by an extended version of DCI Format 2_1). In some examples, the following information may be transmitted by means of the extended DCI format 2_1 with cyclic redundancy check (CRC) scrambled by INT-RNTI. For instance, Pre-emption indication 1, Pre-emption indication 2, . . . , Pre-emption indication N, etc. may be transmitted by means of the extended DCI format 2_1 with cyclic redundancy check (CRC) scrambled by INT-RNTI. For instance, DM-RS replacement configuration 1, DM-RS replacement configuration 2, . . . , DM-RS replacement configuration N, or all pre-emption indications that have the same replacement configuration may be transmitted by means of the extended DCI format 2_1 with cyclic redundancy check (CRC) scrambled by INT-RNTI. For instance, PT-RS replacement configuration 1, PT-RS replacement configuration 2, . . . , PT-RS replacement configuration N, or all pre-emption indications that have the same replacement configuration may be transmitted by means of the extended DCI format 2_1 with cyclic redundancy check (CRC) scrambled by INT-RNTI. For example, besides carrying up to N Pre-emption indications as in the legacy DCI Format 2_1, the extended version of DCI Format 2_1 may carry information of the replacement configuration of the preempted DM-RS REs and/or PT-RS REs. In some examples, a Method 3 message may be a dynamic signaling through DCI. In some examples, a Method 3 message may override Method 1 and/or Message 2.

In some examples, the WTRU may apply the reference signal replacement configuration to obtain the corresponding reference signal REs, and then apply them in the channel estimation, resource demapping, demodulation, decoding, and phase noise compensation.

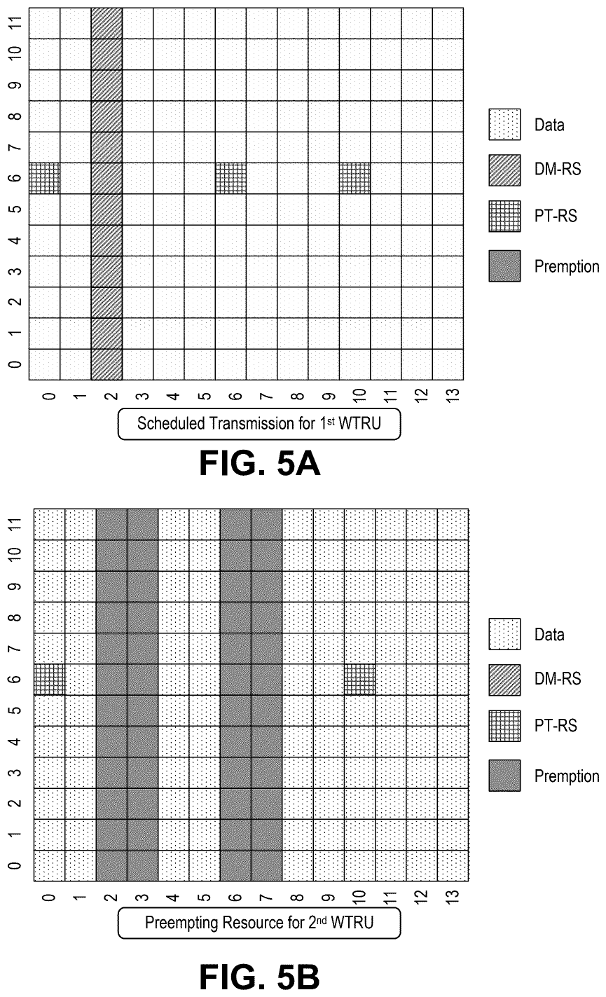

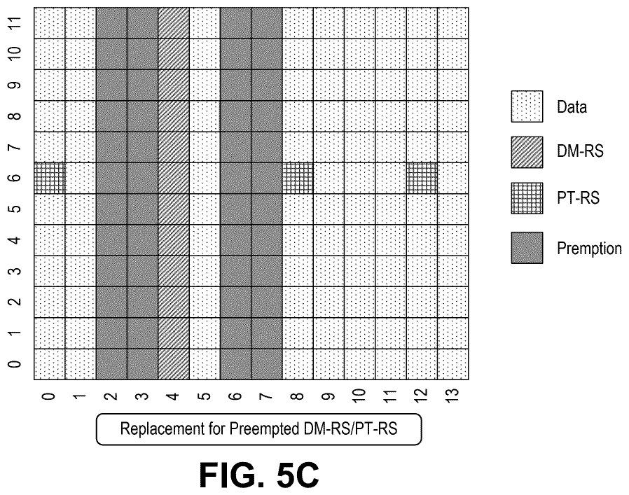

FIG. 5 is a system diagram illustrating an example of replacement configuration for the preempted DM-RS and PT-RS REs according to an embodiment and may demonstrate an example of the rule for the replacement DM-RS and PT-RS configuration. For example, in FIG. 5A, the scheduled slot transmission for the first WTRU is presented, where the DMRS REs are located in the 2nd OFDM symbol and the PT-RS REs are located at 0th, 6th and 10th OFDM symbols. In FIG. 5B, two mini-slots are preempted for a second WTRU with a latency critical transmission. Two OFDM symbols are reserved for each mini-slot. Particularly, the 2nd, 3rd, 6th, 7th OFDM symbols are preempted for the second WTRU, which may lead to preempting the scheduled DM-RS REs and PT-RS REs of the first WTRU. Hence, the first scheduled WTRU may experience data performance degradation due to the lack of DM-RS and PT-RS REs. The method herein may enable the first scheduled WTRU to preserve its data demodulation performance when the OFDM symbols carrying DM-RS and/or PT-RS REs are preempted. In FIG. 5C, illustrates an example replacement configuration for the preempted DM-RS and PT-RS REs. Particularly, the preempted DMRS REs in 2nd OFDM symbol are moved to 4th OFDM symbol. Furthermore, the preempted PT-RS RE in 6th OFDM symbol is moved to 8th OFDM symbol, while the PT-RS RE in 10th OFDM symbol is moved to 12th OFDM symbol to preserve the PT-RS periodicity (e.g., time density).

1. A wireless transmit/receive unit (WTRU) comprising:
a processor configured to:
receive preemption configuration information from a network;
receive a downlink transmission;
determine, using a trained artificial intelligence (AI) or machine learning (ML) model, that one or more resources of the downlink transmission were preempted by the network without receiving a preemption indication and based on the preemption configuration information and measurements performed on the downlink transmission; and
send preemption detection information to the network.

2. The WTRU of claim 1, wherein the preemption configuration information comprises (i) an a priori preemption probability, (ii) an indication of one or more resources that may be preempted in future downlink transmission, (iii) an indication that the a priori preemption probability is associated with one or more preemption patterns associated with future downlink transmissions, (iv) an indication that the a priori preemption probability is associated with a starting orthogonal frequency-division multiplexing (OFDM) symbol of the downlink transmission or (v) an indication that the a priori preemption probability is associated with a starting subcarrier of the downlink transmission.

3. The WTRU of claim 1, wherein the processor is configured to:
receive a request to report preemption operation capabilities; and
send a capabilities message, wherein the capabilities messages indicates that the WTRU supports blind detection of preemption.

4. The WTRU of claim 1, wherein the preemption detection information is sent via uplink control information (UCI) or a medium access control (MAC) control element (CE).

5. The WTRU of claim 1, wherein the preemption detection information indicates one or more physical resource blocks (PRBs) or subcarriers and OFDM Symbols where the WTRU detected preemption, a number of scheduled resource blocks (RBs) that were preempted at a per RB-slot level, a number of scheduled resource blocks (RBs) that were preempted at a per RB level, or a number of scheduled resource blocks (RBs) that were preempted at a per resource element (RE) basis.

6. The WTRU of claim 1, wherein the processor is configured to:
receive preemption training information;
train the AI or ML model for the detection of preemption resources of one or more subsequent downlink transmission based on the preemption training information and using a supervised learning method; and
send training feedback information associated with the AI or ML model to the network via UCI or a MAC-CE.

7. The WTRU of claim 6, wherein the preemption training information comprises (i) randomly generated preemptions generated from a seed, (ii) an indication of one or more downlink resources that will be preempted, (ii) an indication of one or more preemption patterns used to indicate downlink resources that will be preempted, (iii) an a priori preemption probability, or (iv) an indication of one or more resources that may be preempted in future downlink transmission.

8. The WTRU of claim 6, wherein the training feedback information comprises an indication of a loss of the AI or ML model or an indication of a performance metric associated with the AI or ML model.

9. The WTRU of claim 1, wherein the preemption configuration information comprises information to assist the WTRU to determine where preemption might occur in the downlink transmission.

10. The WTRU of claim 1, wherein the preemption information indicates that the WTRU detected preemption of the one or more resources of the downlink transmission.

11. A method performed by a wireless transmit/receive unit (WTRU), the method comprising:
receiving preemption configuration information from a network;
receiving a downlink transmission;
determining, using a trained artificial intelligence (AI) or machine learning (ML) model, that one or more resources of the downlink transmission were preempted by the network without receiving a preemption indication and based on the preemption configuration information and measurements performed on the downlink transmission; and
sending preemption detection information to the network.

12. The method of claim 11, wherein the preemption configuration information comprises (i) an a priori preemption probability, (ii) an indication of one or more resources that may be preempted in future downlink transmission, (iii) an indication that the a priori preemption probability is associated with one or more preemption patterns associated with future downlink transmissions, (iv) an indication that the a priori preemption probability is associated with a starting orthogonal frequency-division multiplexing (OFDM) symbol of the downlink transmission or (v) an indication that the a priori preemption probability is associated with a starting subcarrier of the downlink transmission.

13. The method of claim 11, wherein the processor is configured to:
receive a request to report preemption operation capabilities; and
send a capabilities message, wherein the capabilities messages indicates that the WTRU supports blind detection of preemption.

14. The method of claim 11, wherein the preemption detection information is sent via uplink control information (UCI) or a medium access control (MAC) control element (CE).

15. The method of claim 11, wherein the preemption detection information indicates one or more physical resource blocks (PRBs) or subcarriers and OFDM Symbols where the WTRU detected preemption, a number of scheduled resource blocks (RBs) that were preempted at a per RB-slot level, a number of scheduled resource blocks (RBs) that were preempted at a per RB level, or a number of scheduled resource blocks (RBs) that were preempted at a per resource element (RE) basis.

16. The method of claim 11, wherein the method further comprises:
receiving preemption training information;
training the AI or ML model for the detection of preemption resources of one or more subsequent downlink transmission based on the preemption training information and using a supervised learning method; and
sending training feedback information associated with the AI or ML model to the network via UCI or a MAC-CE.

17. The method of claim 16, wherein the preemption training information comprises (i) randomly generated preemptions generated from a seed, (ii) an indication of one or more downlink resources that will be preempted, (ii) an indication of one or more preemption patterns used to indicate downlink resources that will be preempted, (iii) an a priori preemption probability, or (iv) an indication of one or more resources that may be preempted in future downlink transmission.

18. The method of claim 16, wherein the training feedback information comprises an indication of a loss of the AI or ML model or an indication of a performance metric associated with the AI or ML model.

19. The method of claim 11, wherein the preemption configuration information comprises information to assist the WTRU to determine where preemption might occur in the downlink transmission.

20. A wireless transmit/receive unit (WTRU) comprising:
a processor configured to:
receive a downlink transmission;
determine that one or more resources of the downlink transmission were preempted without receiving a preemption indication and based on measurements performed on the downlink transmission; and
send preemption detection information to the network, wherein the preemption detection information indicates that the WTRU detected preemption of the one or more resources of the downlink transmission.
